(19) United States
(12) Patent Application Publication
(10) Pub. No.: US 2007/0251091 A1
(43) Pub. Date: Nov. 1, 2007

(54) Heat Exchanger And Method For Manufacturing The Same

(75) Inventors: Kazuhiko Minami, Tochigi (JP); Tomoaki Yamanoi, Osaka (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SHOWA DENKO K.K., Minato-ku (JP)

(21) Appl. No.: 10/584,197

(22) PCT Filed: Dec. 24, 2004
(86) PCT No.: PCT/JP04/19796

§ 371 Date: Apr. 20, 2007

Related U.S. Application Data
(60) Provisional application No. 60/532,906, filed on Dec. 30, 2003.

(30) Foreign Application Priority Data
Dec. 24, 2003 (JP) 2003-426408

(51) Int. Cl. B23P 15/26

(52) U.S. Cl. 29/890.054

(57) ABSTRACT

A method for manufacturing a heat exchanger according to the present invention includes the steps of forming a thermally sprayed layer on a surface of an aluminum tube core by thermally spraying Al—Si series alloy brazing material onto the surface of the aluminum tube core to obtain a tube 2, applying flux composite containing non-corrosive flux showing zinc substitution reaction onto a surface of the tube 2, combining the tube 2 with the fin 3, and brazing the tube 2 and the fin 3 in an combined state.

This application claims priority to Japanese Patent Application No. 2003-426-408 filed on Dec. 24, 2003 and U.S. Provisional Application No. 60/532,906 filed on Dec. 30, 2003, the entire disclosures of which are incorporated herein by reference in their entireties.

### CROSS REFERENCE TO RELATED APPLICATIONS

This application is an application filed under 35 U.S.C. §111(a) claiming the benefit pursuant to 35 U.S.C. §119(e)(1) of the filing date of Provisional Application No. 60/532,906 filed on Dec. 30, 2003, pursuant to 35 U.S.C. §111(b).

### BACKGROUND OF THE INVENTION

1. Field of the Invention

The present invention relates to a heat exchanger excellent in corrosion resistance, and its manufacturing method.

In this disclosure, the wording of “aluminum” is used in the meaning including aluminum and its alloy. In this disclosure, “Al” denotes aluminum (metal elementary substance).

2. Description of the Related Art

The following description sets forth the inventor's knowledge of related art and problems therein and should not be construed as an admission of knowledge in the prior art.

As an aluminum heat exchanger, it is known to configure such that a plurality of flat tubes are arranged in the thickness direction with a fin interposed therebetween and hollow headers are connected to both ends of these tubes in fluid communication. The flat tubes and the fins are brazed integrally. In this aluminum heat exchanger, if it is continuously used as it is, pitting corrosion will occur in the tubes, causing penetration of the tubes, which in turn spoils functions as a heat exchanger. To avoid this problem, conventionally, it has been performed that brazing material containing zinc (Al—Si—Zn series brazing material) is thermally sprayed onto surfaces of tubes to diffuse Zn in the tube surface portions to sacrificially protect the tubes (see Japanese Unexamined Laid-open Patent Publication No. S59-10467 (hereinafter referred to as “Patent document l”), claims and page 2, left lower column, and Japanese Unexamined Laid-open Patent Publication No. H1-107961 (hereinafter referred to as “Patent document 2”), claims).

The aforementioned prior art, however, had the following problems. That is, according to the aforementioned prior art, at the time of thermally spraying Al—Si—Zn series alloy brazing material, since the brazing material becomes high in temperature, a phenomenon that low melting point Zn evaporates, thereby causing an uneven adhered amount of Zn.

On the other hand, another sacrificial corrosion prevention method is known. In this method, Zn is diffused in the tube surface portion by applying non-corrosive flux showing zinc substitution reaction onto a flat tube (to which no brazing material is thermally sprayed). In this method, however, the flux slips off the tube surface in a furnace, and therefore it was difficult to cause Zn to be uniformly adhered to the tube surface. To cope with this problem, a method for manufacturing a heat exchanger has been proposed. In this method, a mixed solution consisting of non-corrosive flux showing zinc substitution reaction and acrylic series resin is applied to the surfaces of the tubes. Thereafter, these tubes are assembled together with fins covered with brazing material into a core and heated to braze with each other to thereby obtain a heat exchanger (see Japanese translation of PCT international application Publication No. 2003-514671 (hereinafter referred to as “Patent document 3”), claims and Japanese Unexamined Laid-open Patent Publication No. 2003-225760 (hereinafter referred to as “Patent document 4”), claims). According to this method, it becomes possible to prevent the flux from being slipped off from the tube surfaces in a furnace.

However, in the technique disclosed by the aforementioned Patent documents 3 and 4, there were the following problems. That is, acrylic series resin is high in adhesiveness and the temperature at which acrylic series resin evaporates thoroughly is high, i.e., 400° C. or above. Therefore, at the time of the brazing operation by heating the assembled members, acrylic series resin does not fully evaporate and remains on the tube surfaces, deteriorating the brazing.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide a method for manufacturing a heat exchanger high in corrosion resistance, wherein the method can make a certain amount of Zn adhere on a tube surface and make the Zn diffuse stably, thinly and uniformly and the method also can realize excellent brazing.

To achieve the above objects, the present invention provides the following means.

[1] A method for manufacturing a heat exchanger, the method comprising the steps of:

forming a thermally sprayed layer on a surface of an aluminum tube core by thermally spraying Al—Si series alloy brazing material onto the surface of the aluminum tube core to obtain a tube;

applying flux composite containing non-corrosive flux showing zinc substitution reaction onto a surface of the tube;

combining the tube with the fin; and

brazing the tube and the fin in an combined state.

[2] A method for manufacturing a heat exchanger, the method comprising the steps of:

forming a thermally sprayed layer on a surface of an aluminum tube core by thermally spraying Al—Si series alloy brazing material onto the surface of the aluminum tube core to obtain a tube;

applying flux composite onto a surface of the tube, wherein the flux composite contains non-corrosive flux showing zinc substitution reaction and binder, the binder being resin having a property in which 90 mass % or more of the resin evaporates at a temperature of 350° C. when a differential thermal analysis is performed under a condition of a temperature rising rate of 20° C./minute;

combining the tube with the fin; and

brazing the tube and the fin in a combined state.

[3] The method for manufacturing a heat exchanger as recited in the aforementioned Item [2], wherein butyl series resin is used as the resin.

[4] A method for manufacturing a heat exchanger, the method comprising the steps of:

forming a thermally sprayed layer on a surface of an aluminum tube core by thermally spraying Al—Si series alloy brazing material onto the surface of the aluminum tube core to obtain a tube;

applying flux composite onto a surface of the tube, wherein the flux composite contains non-corrosive flux showing zinc substitution reaction and binder, the binder being polyethylene oxide having a property in which 90 mass % or more of the polyethylene oxide evaporates at a temperature of 350° C. when a differential thermal analysis is performed under a condition of a temperature rising rate of 20° C./minute;

combining the tube with the fin; and

brazing the tube and the fin in an combined state.

[5] The method for manufacturing a heat exchanger as recited in the aforementioned Item [4], wherein a molecular weight of the polyethylene oxide is 10,000 to 1,500,000.

[6] A method for manufacturing a heat exchanger, the method comprising the steps of:

forming a thermally sprayed layer on a surface of an aluminum tube core by thermally spraying Al—Si series alloy brazing material onto the surface of the aluminum tube core to obtain a tube;

applying flux composite onto a surface of the tube, wherein the flux composite contains non-corrosive flux showing zinc substitution reaction and binder, the binder being paraffin having a property in which 90 mass % or more of the paraffin evaporates at a temperature of 350° C. when a differential thermal analysis is performed under a condition of a temperature rising rate of 20° C./minute;

combining the tube with the fin; and

brazing the tube and the fin in an combined state.

[7] The method for manufacturing a heat exchanger as recited in the aforementioned Item [6], wherein a molecular weight of the paraffin is 200 to 600.

[8] The method for manufacturing a heat exchanger as recited in the aforementioned Item [6], wherein one of elements selected from the group consisting of paraffin wax, isoparaffin and cycloparaffin is used as the paraffin.

[9] The method for manufacturing a heat exchanger as recited in any one of the aforementioned Items [2] to [8], wherein a mixed mass ratio in the flux composite is set so as to fall within the range of: the binder material/the flux component containing the non-corrosive flux showing zinc substitution reaction=20/80 to 80/20.

[10] The method for manufacturing a heat exchanger as recited in any one of the aforementioned Items [1] to [9], wherein KZnF₃ is used as the flux component containing the non-corrosive flux showing zinc substitution reaction.

[11] The method for manufacturing a heat exchanger as recited in any one of the aforementioned Items [1] to [10], wherein the flux component containing the non-corrosive flux showing zinc substitution reaction is applied by 5 to 20 g/m².

[12] The method for manufacturing a heat exchanger as recited in any one of the aforementioned Items [1] to [11], wherein alloy brazing material containing Si: 6 to 15 mass % and the balance being Al and inevitable impurities is used as the Al—Si series alloy brazing material.

[13] The method for manufacturing a heat exchanger as recited in any one of the aforementioned Items [1] to [11], wherein alloy brazing material containing Si: 6 to 15 mass %, at least either Cu: 0.3 to 0.6 mass % or Mn: 0.3 to 1.5 mass %, and the balance being Al and inevitable impurities is used as the Al—Si series alloy brazing material.

[14] The method for manufacturing a heat exchanger as recited in any one of the aforementioned Items [1] to [11], wherein alloy brazing material containing Si: 6 to 15 mass %, at least either Cu: 0.35 to 0.55 mass % or Mn: 0.4 to 1.0 mass %, and the balance being Al and inevitable impurities is used as the Al—Si series alloy brazing material.

[15] The method for manufacturing a heat exchanger as recited in any one of the aforementioned Items [1] to [14], wherein a fin with no brazing material clad is used as the fin.

[16] The method for manufacturing a heat exchanger as recited in any one of the aforementioned Items [1] to [15], wherein a flat tube formed by an extrusion is used as the tube.

[17] The method for manufacturing a heat exchanger as recited in any one of the aforementioned Items [1] to [16], wherein the brazing is performed at a heating temperature of 550 to 620° C.

[18] A heat exchanger manufactured by the method as recited in any one of the aforementioned Items [1] to [17].

According to the invention as recited in the aforementioned Item [1], since the non-corrosive flux showing zinc substitution reaction is applied onto the surface of the tube, the Zn in this flux is replaced with Al in the tube surface portion by the heat at the time of the brazing, which forms a zinc diffusion layer on the tube surface portion. At this time, Zn can be uniformly and thinly diffused in a stable manner, or a Zn diffusion depth in the tube becomes smaller, and therefore the obtained heat exchanger is excellent in corrosion resistance. Furthermore, there are minute convexoconcaves and pores on the surface of the tube on which Al—Si series alloy brazing material was thermally sprayed. Accordingly, the non-corrosive flux showing the zinc substitution reaction applied to the tube is caught by the minute convexoconcaves and pores (anchor effects), and therefore the flux adhered to the tube surface hardly slips off the tube surface.

According to the invention as recited in the aforementioned Item [2], since the non-corrosive flux showing zinc substitution reaction is applied onto the surface of the tube, the Zn in this flux is replaced with Al in the tube surface portion by the heat at the time of the brazing, which forms a zinc diffusion layer on the tube surface portion. At this time, Zn can be diffused in the tube uniformly and thinly in a stable manner, or a Zn diffusion depth in the tube becomes smaller, and therefore the obtained heat exchanger is excellent in corrosion resistance. Since the resin is applied together with the non-corrosive flux showing zinc substitution reaction, it is possible to effectively prevent that the flux adhered to the tube surface slips off the tube surface in a brazing furnace, etc. Furthermore, there are minute convexoconcaves and pores on the surface of the tube on which Al—Si series alloy brazing material was thermally sprayed. Accordingly, the non-corrosive flux showing zinc substitution reaction applied to the tube is caught by the minute convexoconcaves and pores (anchor effects), and therefore the slipping-off of the flux adhered to the tube surface from the tube surface can be prevented sufficiently. This enables an adhesion of a predetermined amount of Zn on the tube surface (without causing a non-uniform Zn adhered amount). Furthermore, since as the resin, the resin having a property in which 90 mass % or more of the resin evaporates at a temperature of 350° C. when a differential thermal analysis is performed under a condition of a temperature rising rate of 20° C./minute, almost all of the resin evaporates at the brazing temperature. Therefore, the brazing can be performed without being inhibited by the resin, resulting in good brazing. With this structure, due to the existence of the anchor effect by the thermally sprayed layer on the surface of the tube, it becomes possible to utilize the resin (having a property in which 90 mass % or more of the resin evaporates at a temperature of 350° C. when a differential thermal analysis is performed under a condition of a temperature rising rate of 20° C./minute) which does not exhibit high adhesiveness and evaporates at a relatively low temperature, and this is especially important from the technical point of view.

[3] According to the invention as recited in the aforementioned Item [3], since butyl series resin is used as the resin, there is an advantage that can effectively prevent the surface of the tube from being blackened.

[4] According to the invention as recited in the aforementioned Item [4], since the non-corrosive flux showing zinc substitution reaction is applied onto the surface of the tube, the Zn in this flux is replaced with Al in the tube surface portion by the heat at the time of the brazing, which forms a zinc diffusion layer on the tube surface portion. At this time, Zn can be diffused in the tube uniformly and thinly in a stable manner, or a Zn diffusion depth in the tube becomes smaller, and therefore the obtained heat exchanger is excellent in corrosion resistance. Furthermore, since polyethylene oxide is applied together with the non-corrosive flux showing zinc substitution reaction, it is possible to effectively prevent that the flux adhered to the tube surface slips off the tube surface in a brazing furnace, etc. Furthermore, there are minute convexoconcaves and pores on the surface of the tube on which Al—Si series alloy brazing material was thermally sprayed. Accordingly, the non-corrosive flux showing zinc substitution reaction applied to the tube is caught by the minute convexoconcaves and pores (anchor effects), and therefore the slipping-off of the flux adhered to the tube surface from the tube surface can be prevented sufficiently. This enables an adhesion of a predetermined amount of Zn on the tube surface (without causing a non-uniform Zn adhered amount). Furthermore, since as the polyethylene oxide, polyethylene oxide having a property in which 90 mass % or more thereof evaporates at a temperature of 350° C. when a differential thermal analysis is performed under a condition of a temperature rising rate of 20° C./minute, almost all of them evaporates at the brazing temperature. Therefore, the brazing can be performed without being inhibited by the polyethylene oxide, resulting in good brazing. In addition, since polyethylene oxide is applied, the surface of the tube can be effectively prevented from being blackened. With this structure, due to the existence of the anchor effect by the thermally sprayed layer on the surface of the tube, it becomes possible to utilize the polyethylene oxide (having a property in which 90 mass % or more thereof evaporates at a temperature of 350° C. when a differential thermal analysis is performed under a condition of a temperature rising rate of 20° C./minute) which does not exhibit high adhesiveness and evaporates at a relatively low temperature, and this is especially important from the technical point of view.

[5] According to the invention as recited in the aforementioned Item [5], since polyethylene oxide having a molecular weight of 10,000 to 1,500,000 is used, the polyethylene oxide can assuredly evaporate at the brazing temperature. Therefore, the brazing can be performed without being inhibited by the polyethylene oxide, resulting in good brazing.

[6] According to the invention as recited in the aforementioned Item [6], since the non-corrosive flux showing zinc substitution reaction is applied onto the surface of the tube, the Zn in this flux is replaced with Al in the tube surface portion by the heat at the time of the brazing, which forms a zinc diffusion layer on the tube surface portion. At this time, Zn can be diffused in the tube uniformly and thinly in a stable manner, or a Zn diffusion depth in the tube becomes smaller, and therefore the obtained heat exchanger is excellent in corrosion resistance. Furthermore, since paraffin is applied together with the non-corrosive flux showing zinc substitution reaction, it is possible to effectively prevent that the flux adhered to the tube surface slips off the tube surface in a brazing furnace, etc. Furthermore, there are minute convexoconcaves and pores on the surface of the tube on which Al—Si series alloy brazing material was thermally sprayed. Accordingly, the non-corrosive flux showing zinc substitution reaction applied to the tube is caught by the minute convexoconcaves and pores (anchor effects), and therefore the slipping-off of the flux adhered to the tube surface from the tube surface can be prevented sufficiently. This enables an adhesion of a predetermined amount of Zn on the tube surface (without causing a non-uniform Zn adhered amount). Furthermore, since as the paraffin, paraffin having a property in which 90 mass % or more thereof evaporates at a temperature of 350° C. when a differential thermal analysis is performed under a condition of a temperature rising rate of 20° C./minute, almost all of them evaporates at the brazing temperature. Therefore, the brazing can be performed without being inhibited by the paraffin, resulting in good brazing. In addition, since paraffin is applied, the surface of the tube can be effectively prevented from being blackened. With this structure, due to the existence of the anchor effect by the thermally sprayed layer on the surface of the tube, it becomes possible to utilize the paraffin (having a property in which 90 mass % or more thereof evaporates at a temperature of 350° C. when a differential thermal analysis is performed under a condition of a temperature rising rate of 20° C./minute) which does not exhibit high adhesiveness and evaporates at a relatively low temperature, and this point is especially important from the technical point of view.

[7] According to the invention as recited in the aforementioned Item [7], since paraffin having a molecular weight of 200 to 600 is used, the paraffin can assuredly evaporate at the brazing temperature. Therefore, the brazing can be performed without being inhibited by the paraffin, resulting in good brazing.

[8] According to the invention as recited in the aforementioned Item [8], since one of elements selected from the group consisting of paraffin wax, isoparaffin and cycloparaffin is used as the paraffin, the paraffin can assuredly evaporate at the brazing temperature. Therefore, the brazing can be performed without being inhibited by the paraffin, resulting in good brazing.

[9] According to the invention as recited in the aforementioned Item [9], the slipping-off of the flux adhered to the tube surface can be assuredly prevented.

[10] According to the invention as recited in the aforementioned Item [10], KZnF₃ is used as the flux component, the Zn in this flux is replaced with Al in the surface portion of the tube by the heat at the time of brazing, and the created KAlF₄ exhibits excellent effects as flux. Accordingly, more suitable brazing can be performed.

[11] According to the invention as recited in the aforementioned Item [11], since the flux is applied by 5 to 20 g/m², corrosion resistance can be further improved and an occurrence of fin detachment can also be prevented.

[12] According to the invention as recited in the aforementioned Item [12],

good brazing can be performed without causing erosion.

[13] According to the invention as recited in the aforementioned Item [13],

since the corrosion depth of the tube can be reduced, it becomes possible to meet the demand of decreasing a tube thickness.

[14] According to the invention as recited in the aforementioned Item [14], a tube thickness can be further decreased.

[15] According to the invention as recited in the aforementioned Item [15], since the productive efficiency can be improved, a high quality heat exchanger can be manufactured at low cost.

[16] According to the invention as recited in the aforementioned Item [16], since the productive efficiency can be improved, a high quality heat exchanger can be manufactured at low cost.

[17] According to the invention as recited in the aforementioned Item [17],

since the heating temperature at the time of brazing is set within the specific range, Zn diffusion can be made fully and good brazing can be performed efficiently.

[18] According to the invention as recited in the aforementioned Item [18], a heat exchanger high in corrosion resistance and excellent in joining strength can be provided.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a front view showing an embodiment of a heat exchanger manufactured by a manufacturing method of the present invention; and

FIG. 2 is a perspective partial view showing tubes and fins in an assembled state.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

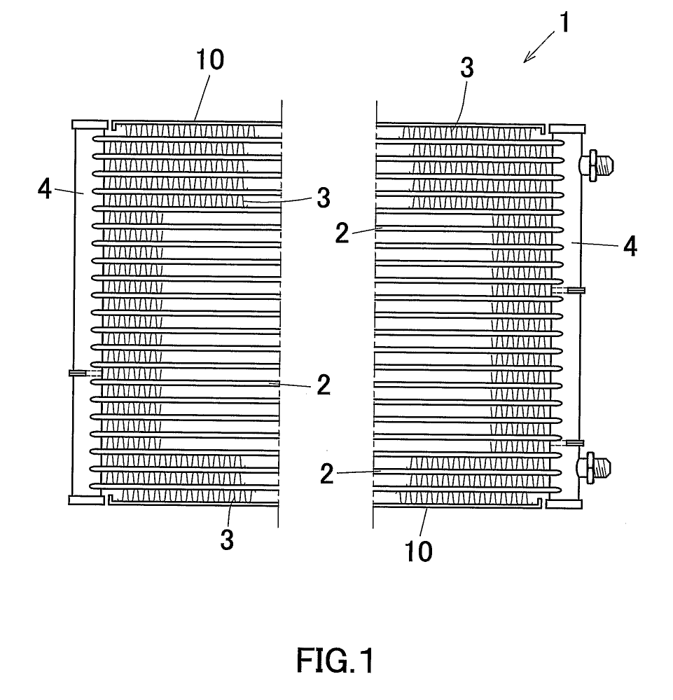

FIG. 1 is a front view showing a heat exchanger according to an embodiment of the present invention. This heat exchanger 1 is used as a condenser for use in a refrigeration cycle for automobile air-conditioning systems, and constitutes the so-called multi-flow type heat exchanger. In detail, this heat exchanger 1 includes a pair of right and left hollow headers 4 and 4 vertically disposed in parallel, a plurality of flat tubes 2 as heat exchanging passages disposed horizontally in parallel between the hollow headers 4 and 4 with the opposite ends thereof connected to the hollow headers 4 and 4 in a fluid communication, corrugated fins 3 disposed between adjacent tubes 2 and at the outside of the outermost tubes, and side plates 10 disposed at the outside of the outermost corrugated fins 3 and 3.

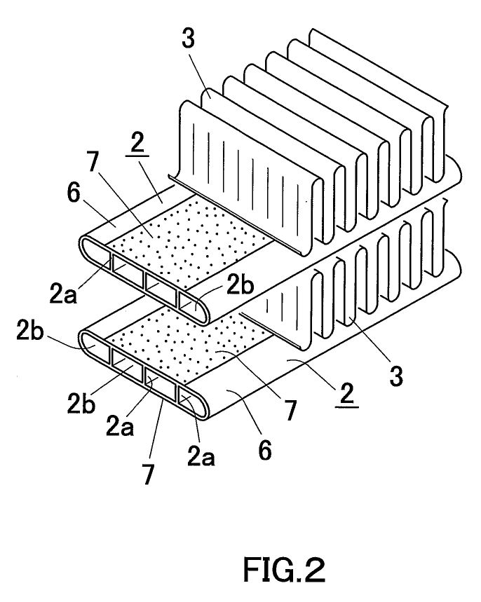

The tube 2 is an aluminum hollow extruded member. As shown in FIG. 2, the inside of the tube 2 is divided by partitions 2a continuously extending in the longitudinal direction into a plurality of refrigerant passages 2b. The tube 2 has a thermally sprayed brazing material layer 7 formed by thermally spraying Al—Si series alloy brazing material onto the surface of the tube core 6. On the surface portion of the tube core 6, a zinc diffusion layer formed by replacing Zn in the flux used for brazing with Al in the surface portion of the tube core 6 is formed. The corrugated fin 3 is a fin with no brazing material clad thereon. These tubes 2 and fins 3 are brazed by brazing material in a state in which the tubes 2 and the fins 3 are arranged in an alternative manner.

Now, a method for manufacturing a heat exchanger 1 according to the present invention will be explained as follows. Initially, a tube 2 with a thermally sprayed brazing material layer 7 is manufactured by spraying brazing material of Al—Si series alloy onto a surface of an aluminum tube core 6.

As the Al—Si series alloy brazing material, it is not limited to a specific one. However, it is preferable to use alloy brazing material consisting of Si: 6 to 15 mass %, at least either Cu: 0.3 to 0.6 mass % or Mn: 0.3 to 1.5 mass %, and the balance being Al and inevitable impurities. Although Si is an essential element to perform the brazing, if the content of Si is less than 6 mass %, it is not preferable since the brazing joint strength deteriorates. On the other hand, if the content of Si exceeds 15 mass %, it is not preferable since there is a possibility that erosion occurs to corrode tubes. The most preferable Si content is 6 to 12.5 mass %. Adding of Cu and/or Mn causes a rise in electric potential of a fillet, which in turn can decrease the corrosion depth. If the content of Cu is less than 0.3 mass %, it is not preferable since the corrosion depth decreasing effects can be hardly obtained. On the other hand, if the content of Cu exceeds 0.6 mass %, it is also not preferable since intergranular corrosion occurs easily and therefore corrosion resistance of the tube deteriorates. The most preferable Cu content is 0.35 to 0.55 mass %. If the content of Mn is less than 0.3 mass %, it is not preferable since the corrosion depth decreasing effects can be hardly attained. On the other hand, if the content of Mn exceeds 1.5 mass %, it is also not preferable since rough intermetallic compounds easily generate and therefore brazing performance deteriorates. The most preferable Mn content is 0.4 to 1.0 mass %.

In the Al—Si series alloy brazing material, Fe can be contained if Fe is 0.6 mass % or less. Furthermore, metallic elements such as In, Sn, Ni, Ti and Cr can also be contained so long as the content thereof falls within a range which does not affect the brazing performance. In addition, Zn can also be contained so long as the content thereof falls within a range which does not excessively increase the thickness of a Zn diffusion layer in the tube and does not affect the corrosion resistance.

Although the thermal spraying method is not limited to a specific one, for example, a method using a conventional arc-spraying machine can be exemplified. Although the thermally spraying conditions are not specifically limited, it is preferable to perform the thermal spraying in a non-oxidizing atmosphere, such as a nitrogen atmosphere, to prevent oxidation of a thermally sprayed layer 7 to be formed. The thermal spraying can be performed while moving a spraying gun along the tube or while unwinding a coiled aluminum material with a spraying gun fixed. Alternatively, the thermal spraying can be continuously performed while extruding a tube from an extruding machine. In this case, the productive efficiency can be improved. Furthermore, the thermally sprayed layer can be formed only on one side of the tube, and also can be formed on both sides of the tube, or upper and lower sides thereof.

Next, on the surface of the tube 2, flux composite containing non-corrosive flux showing zinc substitution reaction is applied. As this flux composite, it is preferable to use any one of the following flux composite A, flux composite B and flux composite C. “The flux composite A” is a flux composite containing binder made of resin having a property in which 90 mass % or more of the resin evaporates at a temperature of 350° C. when a differential thermal analysis is performed under a condition of a temperature rising rate of 20° C./minute and non-corrosive flux showing zinc substitution reaction. “The flux composite B” is a flux composite containing binder made of polyethylene oxide having a property in which 90 mass % or more of the polyethylene oxide evaporates at a temperature of 350° C. when a differential thermal analysis is performed under a condition of a temperature rising rate of 20° C./minute and non-corrosive flux showing zinc substitution reaction. “The flux composite C” is a flux composite containing binder made of paraffin having a property in which 90 mass % or more of the paraffin evaporates at a temperature of 350° C. when a differential thermal analysis is performed under a condition of a temperature rising rate of 20° C./minute and non-corrosive flux showing zinc substitution reaction. The analyses initiation temperature in the differential thermal analysis shall be set to 25° C., and the amount of binder material at the time of performing the differential thermal analysis is set to 20 mg.

Any binder other than the aforementioned specific resin (resin having a property in which 90 mass % or more of the resin evaporates at a temperature of 350° C. when a differential thermal analysis is performed under a condition of a temperature rising rate of 20° C./minute) can be mixed in the aforementioned flux composite A so long as such binder falls within a range in which the effects of the present invention is not inhibited. In the same manner, the flux composite B can contain any other binder other than the above-identified polyethylene oxide (polyethylene oxide having a property in which 90 mass % or more thereof evaporates at a temperature of 350° C. when a differential thermal analysis is performed under a condition of a temperature rising rate of 20° C./minute) if the content falls within the range which does not obstruct the effects of the present invention. Furthermore, similarly, the flux composite C can contain any other binder other than the above-identified paraffin (paraffin having a property in which 90 mass % or more thereof evaporates at a temperature of 35° C. when a differential thermal analysis is performed under a condition of a temperature rising rate of 20° C./minute) if the content falls within the range which does not obstruct the effects of the present invention.

Although the non-corrosive flux showing zinc substitution reaction is not limited to a specific one, KZnF₃ and ZnF₂ can be exemplified. Among these, it is preferable to use KZnF₃. In this case, Zn in this flux is replaced with Al in the surface portion of the tube, while the created KAlF₄ exhibits excellent effects as flux. Therefore, there is an advantage that can assuredly perform good brazing.

Although the method for applying the aforementioned flux composite is not specifically limited, for example, a method for spraying the flux composite as it is, a method for spraying the flux composite suspended in water, and a method for spraying electrostatically charged flux composite can be exemplified. In cases where binder is used, in addition to the above exemplified methods, a method for roll coating the flux composite can be exemplified. The flux composite can contain any other non-corrosive flux (non-corrosive flux not showing zinc substitution reaction) so long as the content thereof does not obstruct the effects the present invention.

The applying amount of the non-corrosive flux showing zinc substitution reaction is usually 2 to 30 g/m². However, it is preferable to set the amount within a range of from 5 to 20 g/m². If it is less than 5 g/m², it is not preferable since pitting corrosion may occur in a tube. On the other hand, if it exceeds 20 g/m², it is not preferable since there is a possibility that Zn is condensed in the fin and therefore the fin detachment may occur.

As the resin having a property in which 90 mass % or more thereof evaporates at a temperature of 350° C. when a differential thermal analysis is performed under a condition of a temperature rising rate of 20° C./minute, butyl series resin can be exemplified. By applying such resin together with the non-corrosive flux showing zinc substitution reaction, it becomes possible to effectively prevent the slipping-off of the flux adhered to the tube surface in a brazing furnace. Furthermore, since the resin has a property in which 90 mass % or more of the resin evaporates at a temperature of 350° C. when a differential thermal analysis is performed under a condition of a temperature rising rate of 20° C./minute, almost all of the resin evaporates at the brazing temperature, and therefore good brazing can be performed without being obstructed. Especially, it is preferable to use butyl series resin. In this case, there is an advantage that can prevent the tube surface from being blackened. As the butyl series resin, polybutene and polyisobutene can be exemplified.

As the polyethylene oxide having a property in which 90 mass % or more thereof evaporates at a temperature of 350° C. when a differential thermal analysis is performed under a condition of a temperature rising rate of 20° C./minute, polyethylene oxide having a molecular weight of 50,000 and polyethylene oxide having a molecular weight of 1,000,000 can be exemplified. By applying such polyethylene oxide together with the non-corrosive flux showing zinc substitution reaction, it becomes possible to effectively prevent the slipping-off of the flux adhered to the tube surface in a brazing furnace. Furthermore, since the polyethylene oxide has a property in which 90 mass % or more thereof evaporates at a temperature of 350° C. when a differential thermal analysis is performed under a condition of a temperature rising rate of 20° C./minute, almost all of them evaporates at the brazing temperature, and therefore good brazing can be performed without being obstructed. Furthermore, by using polyethylene oxide as binder, it becomes possible to prevent the tube surface from being blackened.

As the polyethylene oxide (PEO), it is preferable to use polyethylene oxide having a molecular weight of 10,000 to 1,500,000. In this case, since the evaporating temperature is low and evaporation can be completed for a short time, polyethylene oxide evaporates assuredly at the brazing temperature. Accordingly, the brazing will not be obstructed by the polyethylene oxide, and the brazing can fully be performed. Especially, as the polyethylene oxide (PEO), it is more preferable to use polyethylene oxide having a molecular weight of 100,000 to 1,000,000.

As the paraffin having a property in which 90 mass % or more thereof evaporates at a temperature of 350° C. when a differential thermal analysis is performed under a condition of a temperature rising rate of 20° C./minute, paraffin wax, isoparaffin, cycloparaffin can be exemplified. By applying such paraffin together with the non-corrosive flux showing zinc substitution reaction, it becomes possible to effectively prevent the slipping-off of the flux adhered to the tube surface in a brazing furnace. Furthermore, since the paraffin has a property in which 90 mass % or more thereof evaporates at a temperature of 350° C. when a differential thermal analysis is performed under a condition of a temperature rising rate of 20° C./minute, almost all of them evaporates at the brazing temperature, and therefore good brazing can be performed without being obstructed. Furthermore, by using paraffin as binder, it becomes possible to prevent the tube surface from being blackened.

As the paraffin, it is preferable to use paraffin having a molecular weight of 200 to 600. In this case, since the evaporating temperature is low and evaporation can be completed for a short time, the paraffin evaporates assuredly at the brazing temperature. Accordingly, the brazing will not be obstructed by the paraffin, and the brazing can fully be performed. Especially, as the paraffin, it is more preferable to use paraffin having a molecular weight of 250 to 400.

In the flux composite, it is preferable that a mixed mass ratio in the flux composite is set so as to fall within the range of: the binder material/the flux component containing the non-corrosive flux showing zinc substitution reaction=20/80 to 80/20. If the content ratio of the binder becomes smaller than the above-mentioned lower limit, it is not preferable since the assuredness of preventing the slipping-off of the flux adhered to the tube surface deteriorates. On the other hand, if the content ratio of the flux component containing the non-corrosive flux becomes smaller than the above-mentioned lower limit, it is not preferable since Zn will not be sufficiently supplied to the tube surface and therefore and corrosion resistance deteriorates. Especially, it is more preferable that a mixed mass ratio in the flux composite is set so as to fall within the range of: the binder material/the flux component containing the non-corrosive flux showing zinc substitution reaction=40/60 to 60/40.

Next, the fin 3 is combined with the tube 2 to which the flux composite was applied. As the fin 3, a fin with no brazing material clad is used. Since the brazing material 7 is provided on the surface of the tube 2, it is not always necessary to use a fin with brazing material clad. In a combined state, the tubes 2 and the fins 3 are brazed by heating at a predetermined temperature. At the time of brazing, it is recommended that other members, such as headers 4 and side plates 10 and 10, are assembled together with the tubes 2 and fins 3 into a provisionally assembled heat exchanger, and all of the members constituting the provisionally assembled heat exchanger are simultaneously brazed. In this way, the heat exchanger 1 as shown in FIG. 1 can be manufactured. Thus, during the step of raising the temperature by the heat at the time of brazing, Zn in the flux is replaced with Al in the surface portion of the tube (replacement reaction advances), and thus a zinc diffusion layer is formed in the tube surface portion. At this time, Zn can be diffused uniformly and thinly in a stable manner and the Zn diffusion depth in the tube can be small, resulting in sufficient corrosion resistance of the tube.

Especially, the heating temperature at the time of the brazing is preferably to set so as to fall within the range of 550 to 620° C. If the heating temperature becomes lower than the lower limit, it is not preferable because the Zn diffusion in the tube surface portion becomes insufficient, which in turn causes a deterioration of sacrificial corrosion prevention function. On the other hand, if the heating temperature becomes higher than the upper limit, it is also not preferable because the brazing material erodes. Especially, it is more preferable that the heating temperature at the time of brazing is set so as to fall within the range of 590 to 610° C.

In the above-mentioned embodiment, flux composite is applied to a surface of a tube and thereafter the tube is combined with a fin. However, after combining a fin with a tube into an assembly, flux composite can be applied to the assembly.

Next, concrete examples of the present invention will be explained.

### EXAMPLE 1

To upper and lower flat surfaces of an aluminum flat tube continuously extruded from an extruder, brazing material of Al—Si series alloy (Si content: 6 mass %, the balance being Al) was thermally sprayed at a position immediately after the extrusion from a thermal spraying gun (arc-spraying machine) arranged above and below the tube. The extruded flat tube was extruded into a flat tube having a tube width of 16 mm, a tube thickness (height) of 3 mm, a wall thickness of 0.5 mm and four hollow portions by using aluminum alloy (Cu content: 0.4 mass %, Mn content: 0.2 mass %, the balance being Al) under the condition of a temperature of 450° C.

On the surface of the flat tube 2, flux composite (KZnF₃ powder is distributed in paraffin) of KZnF₃/paraffin=50/50 (mass ratio) was applied. At this time, the flux composite was applied such that the sprayed amount of KZnF₃ became 10 g/m².

As the paraffin, paraffin wax (molecular weight of 300) was used. This paraffin exhibited a property in which 98 mass % or more thereof evaporated at a temperature of 350° C. when a differential thermal analysis was performed under the conditions of a temperature rising rate of 20° C./minute and an initial temperature of 25° C.

Next, the aforementioned flat tubes 2 and corrugated fins (with no brazing material clad) 3 were arranged alternatively (see FIG. 2) to assemble (provisionally assemble) a core portion of a heat exchanger together with headers 4 and 4, side plates 10 and 10, and other parts to thereby obtain a provisional assembly.

Thereafter, the assembly was subjected to brazing by heating for 10 minutes at 600° C. in a nitrogen atmosphere furnace, and a heat exchanger as shown in FIG. 1 was manufactured.

### EXAMPLES 2 TO 40

A heat exchanger was manufactured in the same manner as in Example 1 except that various conditions (composition of brazing material, composition of flux composite and applied amount of KZnF₃) were set to the conditions shown in Tables 1 to 4.

The isoparaffin exhibited a property in which 95 mass % thereof evaporated at a temperature of 350° C. when a differential thermal analysis was performed under the conditions of a temperature rising rate of 20° C./minute and an initial temperature of 25° C. The cycloparaffin exhibited a property in which 95 mass % thereof evaporated at a temperature of 350° C. when a differential thermal analysis was performed under the conditions of a temperature rising rate of 20° C./minute and an initial temperature of 25° C.

As butyl series resin, polybutene was used. This butyl series resin exhibited a property in which 95 mass % thereof evaporated at a temperature of 350° C. when a differential thermal analysis was performed under the conditions of a temperature rising rate of 20° C./minute and an initial temperature of 25° C.

As polyethylene oxide (PEO), polyethylene oxide having a molecular weight of 300,000, polyethylene oxide having a molecular weight of 400,000, polyethylene oxide having a molecular weight of 500,000, polyethylene oxide having a molecular weight of 600,000, and polyethylene oxide having a molecular weight of 750,000 were used. These polyethylene oxide exhibited a property in which 98 mass % thereof evaporated at a temperature of 350° C. when a differential thermal analysis was performed under the conditions of a temperature rising rate of 20° C./minute and an initial temperature of 25° C.

### COMPARATIVE EXAMPLE 1

To upper and lower flat surfaces of an aluminum flat tube continuously extruded from an extruder, Al alloy brazing material containing Zn (Si content: 7.5 mass %, Zn content: 4 mass %, Cu content: 0.4 mass %, Al content: 88.1 mass %) was thermally sprayed at a position immediately after the extrusion from a thermal spraying gun (arc-spraying machine) arranged above and below the tube. The extruded flat tube was extruded into a flat tube having a tube width of 16 mm, a tube thickness (height) of 3 mm, a wall thickness of 0.5 mm and four hollow portions by using aluminum alloy (Cu content: 0.4 mass %, Mn content: 0.2 mass %, the balance being Al) under the condition of a temperature of 450° C.

Next, the aforementioned flat tubes 2 and corrugated fins (with no brazing material clad) 3 were arranged alternatively (see FIG. 2) to assemble (provisionally assemble) a core portion of a heat exchanger together with headers 4 and 4, side plates 10 and 10, and other parts to thereby obtain a provisional assembly.

To the provisional assembly, KAlF₃ (non-corrosive flux not showing zinc replacement reaction) was applied. At this time, the flux was applied such that the sprayed amount of KAlF₃ became 10 g/m². Next, the assembly was subjected to brazing by heating for 10 minutes at 600° C. in a nitrogen atmosphere furnace to thereby manufacture a heat exchanger.

TABLE 1

| | Composition of brazing material | | | | | | | |
|---|---|---|---|---|---|---|---|---|
| | (balance: Al) | | | | KZnF₃ | Evaluation | | |
| | Si content | Cu content | Mn content | Composition of flux | applied amount | Corrosion test 1 | Corrosion test 2 | Fin |
| | (mass %) | (mass %) | (mass %) | composite (mass part) | (g/m²) | (SWAAT) | (CCT) | detachment |
| Example 1 | 6 | 0 | 0 | KZnF₃/paraffin | 10 | ⊚ | ⊚ | None |
| | | | | wax = 50/50 | | | | |
| Example 2 | 10 | 0.1 | 0 | KZnF₃/paraffin | 10 | ⊚ | ◯ | None |
| | | | | wax = 50/50 | | | | |
| Example 3 | 10 | 0.35 | 0 | KZnF₃/paraffin | 2 | ⊚ | Δ | None |
| | | | | wax = 50/50 | | | | |
| Example 4 | 10 | 0.35 | 0 | KZnF₃/paraffin | 5 | ⊚ | ⊚ | None |
| | | | | wax = 50/50 | | | | |
| Example 5 | 10 | 0.35 | 0 | KZnF₃/paraffin | 10 | ⊚ | ⊚ | None |
| | | | | wax = 50/50 | | | | |
| Example 6 | 10 | 0.35 | 0 | KZnF₃/paraffin | 20 | ⊚ | ⊚ | None |
| | | | | wax = 50/50 | | | | |
| Example 7 | 10 | 0.35 | 0 | KZnF₃/paraffin | 30 | Δ | ◯ | None |
| | | | | wax = 50/50 | | | | |

TABLE 2

| | Composition of brazing material | | | | | | | |
|---|---|---|---|---|---|---|---|---|
| | (balance: Al) | | | | KZnF₃ | Evaluation | | |
| | Si content | Cu content | Mn content | Composition of flux | Applied amount | Corrosion test 1 | Corrosion test 2 | Fin |
| | (mass %) | (mass %) | (mass %) | composite (mass part) | (g/m²) | (SWAAT) | (CCT) | detachment |
| Example 8 | 10 | 0.5 | 0 | KZnF₃/paraffin | 5 | ⊚ | ⊚ | None |
| | | | | wax = 50/50 | | | | |
| Example 9 | 10 | 0.5 | 0 | KZnF₃/paraffin | 10 | ⊚ | ⊚ | None |
| | | | | wax = 50/50 | | | | |
| Example 10 | 10 | 0.5 | 0 | KZnF₃/paraffin | 20 | ⊚ | ⊚ | None |
| | | | | wax = 50/50 | | | | |
| Example 11 | 10 | 0.5 | 0.3 | KZnF₃/cyclo- | 10 | ⊚ | ⊚ | None |
| | | | | paraffin = 60/40 | | | | |
| Example 12 | 10 | 0.5 | 0.6 | KZnF₃/iso- | 10 | ⊚ | ⊚ | None |
| | | | | paraffin = 40/60 | | | | |
| Example 13 | 10 | 0.5 | 1.5 | KZnF₃/iso- | 10 | ⊚ | ⊚ | None |
| | | | | paraffin = 70/30 | | | | |
| Example 14 | 10 | 0.4 | 0.6 | KZnF₃/cyclo- | 10 | ⊚ | ⊚ | None |
| | | | | paraffin = 30/70 | | | | |
| Example 15 | 12 | 0.4 | 0 | KZnF₃/paraffin | 5 | ⊚ | ⊚ | None |
| | | | | wax = 50/50 | | | | |
| Example 16 | 12 | 0.4 | 0 | KZnF₃/paraffin | 10 | ⊚ | ⊚ | None |
| | | | | wax = 50/50 | | | | |
| Example 17 | 12 | 0.4 | 0 | KZnF₃/paraffin | 20 | ⊚ | ⊚ | None |
| | | | | wax = 50/50 | | | | |
| Example 18 | 12 | 0.6 | 0 | KZnF₃/paraffin | 10 | ⊚ | ⊚ | None |
| | | | | wax = 50/50 | | | | |

| | | | | | | |
|---|---|---|---|---|---|---|
| Com. Ex. 1 | Al brazing material containing Zn*¹⁾ | Only KAlF₃ | 10*²⁾ | Δ | Δ | None |

*¹⁾Si/Zn/Cu/Al = 7.5/4/0.4/88.1 (mass %)
*²⁾KAlF3 applied amount

TABLE 3

| | Composition of brazing material | | | | | | | |
|---|---|---|---|---|---|---|---|---|
| | (balance: Al) | | | | KZnF₃ | Evaluation | | |
| | Si content | Cu content | Mn content | Composition of flux | Applied amount | Corrosion test 1 | Corrosion test 2 | Fin |
| | (mass %) | (mass %) | (mass %) | composite (mass part) | (g/m²) | (SWAAT) | (CCT) | detachment |
| Example 19 | 10 | 0.5 | 0 | KZnF₃/butyl series | 5 | ⊚ | ⊚ | None |
| | | | | resin = 50/50 | | | | |
| Example 20 | 10 | 0.5 | 0 | KZnF₃/butyl series | 10 | ⊚ | ⊚ | None |
| | | | | resin = 50/50 | | | | |
| Example 21 | 10 | 0.5 | 0 | KZnF₃/butyl series | 20 | ⊚ | ⊚ | None |
| | | | | resin = 50/50 | | | | |
| Example 22 | 10 | 0.5 | 0.3 | KZnF₃/butyl series | 10 | ⊚ | ⊚ | None |
| | | | | resin = 60/40 | | | | |
| Example 23 | 10 | 0.5 | 0.6 | KZnF₃/butyl series | 10 | ⊚ | ⊚ | None |
| | | | | resin = 40/60 | | | | |
| Example 24 | 10 | 0.5 | 1.5 | KZnF₃/butyl series | 10 | ⊚ | ⊚ | None |
| | | | | resin = 70/30 | | | | |
| Example 25 | 10 | 0.4 | 0.6 | KZnF₃/butyl series | 10 | ⊚ | ⊚ | None |
| | | | | resin = 30/70 | | | | |
| Example 26 | 12 | 0.4 | 0 | KZnF₃/butyl series | 5 | ⊚ | ⊚ | None |
| | | | | resin = 50/50 | | | | |
| Example 27 | 12 | 0.4 | 0 | KZnF₃/butyl series | 10 | ⊚ | ⊚ | None |
| | | | | resin = 50/50 | | | | |
| Example 28 | 12 | 0.4 | 0 | KZnF₃/butyl series | 20 | ⊚ | ⊚ | None |
| | | | | resin = 50/50 | | | | |
| Example 29 | 12 | 0.6 | 0 | KZnF₃/butyl series | 10 | ⊚ | ⊚ | None |
| | | | | resin = 50/50 | | | | |

TABLE 4

| | Composition of brazing material | | | | | | | |
|---|---|---|---|---|---|---|---|---|
| | (balance: Al) | | | | KZnF₃ | Evaluation | | |
| | Si content | Cu content | Mn content | Composition of flux | Applied amount | Corrosion test 1 | Corrosion test 2 | Fin |
| | (mass %) | (mass %) | (mass %) | composite (mass part) | (g/m²) | (SWAAT) | (CCT) | detachment |
| Example 30 | 10 | 0.5 | 0 | Water/KZnF₃/PEO | 5 | ⊚ | ⊚ | None |
| | | | | (M = 500,000) = | | | | |
| | | | | 75/20/5 | | | | |
| Example 31 | 10 | 0.5 | 0 | Water/KZnF₃/PEO | 10 | ⊚ | ⊚ | None |
| | | | | (M = 500,000) = | | | | |
| | | | | 75/20/5 | | | | |
| Example 32 | 10 | 0.5 | 0 | Water/KZnF₃/PEO | 20 | ⊚ | ⊚ | None |
| | | | | (M = 500,000) = | | | | |
| | | | | 75/20/5 | | | | |
| Example 33 | 10 | 0.5 | 0.3 | Water/KZnF₃/PEO | 10 | ⊚ | ⊚ | None |
| | | | | (M = 300,000) = | | | | |
| | | | | 75/20/5 | | | | |
| Example 34 | 10 | 0.5 | 0.6 | Water/KZnF₃/PEO | 10 | ⊚ | ⊚ | None |
| | | | | (M = 400,000) = | | | | |
| | | | | 75/15/10 | | | | |
| Example 35 | 10 | 0.5 | 1.5 | Water/KZnF₃/PEO | 10 | ⊚ | ⊚ | None |
| | | | | (M = 600,000) = | | | | |
| | | | | 75/10/15 | | | | |
| Example 36 | 10 | 0.4 | 0.6 | Water/KZnF₃/PEO | 10 | ⊚ | ⊚ | None |
| | | | | (M = 750,000) = | | | | |
| | | | | 75/20/5 | | | | |
| Example 37 | 12 | 0.4 | 0 | Water/KZnF₃/PEO | 5 | ⊚ | ⊚ | None |
| | | | | (M = 500,000) = | | | | |
| | | | | 75/20/5 | | | | |
| Example 38 | 12 | 0.4 | 0 | Water/KZnF₃/PEO | 10 | ⊚ | ⊚ | None |
| | | | | (M = 500,000) = | | | | |
| | | | | 75/20/5 | | | | |
| Example 39 | 12 | 0.4 | 0 | Water/KZnF₃/PEO | 20 | ⊚ | ⊚ | None |
| | | | | (M = 500,000) = | | | | |
| | | | | 75/20/5 | | | | |
| Example 40 | 12 | 0.6 | 0 | Water/KZnF₃/PEO | 10 | ⊚ | ⊚ | None |
| | | | | (M = 500,000) = | | | | |
| | | | | 75/20/5 | | | | |

PEO (M = 300,000) Polyethylene oxide having a molecular weight of 300,000
PEO (M = 400,000) Polyethylene oxide having a molecular weight of 400,000
PEO (M = 500,000) Polyethylene oxide having a molecular weight of 500,000
PEO (M = 600,000) Polyethylene oxide having a molecular weight of 600,000
PEO (M = 750,000) Polyethylene oxide having a molecular weight of 750,000

About each heat exchanger obtained as mentioned above, “corrosion resistance” and “existence (brazed condition) of fin detachment” were investigated. These results are shown in each table. The valuation method of each item is as follows.

<Corrosion Test 1>

A SWAAT test in accordance with a ASTM D1141 was performed for 960 hours and the results are shown as follows:

⊚: no pitting corrosion was observed in the tube, and the heat exchanger had outstanding corrosion resistance;

“∘”: although pitting corrosion was slightly observed in the tube, the corrosion depth was very shallow, and the heat exchanger had good corrosion resistance;

“Δ”: although pitting corrosion was observed in the tube, it did not reach the inside of the tube; and

“x”: pitting corrosion reached the inside of the tube.

<Corrosion Test 2>

A CCT test performing salt water spraying, drying, and wetting with 5% NaCl neutral liquid as one cycle was performed for 180 days, and the results are shown as follows:

“⊚”: no pitting corrosion was observed in the tube, and the heat exchanger had outstanding corrosion resistance;

“∘”: although pitting corrosion was slightly observed in the tube, the corrosion depth was very shallow, and the heat exchanger had good corrosion resistance;

“Δ”: although pitting corrosion was observed in the tube, it did not reach the inside of the tube; and

“x”: pitting corrosion reached the inside of the tube.

The CCT tests (salt water spraying: 1 hour, drying: 2 hours, and wetting: 21 hours constitutes one cycle) were performed by 180 cycles.

<Existence of Fin Detachment>

After performing the SWAAT test for 960 hours, the existence of fin detachment (detachment of the fin from the tube) was investigated, and brazing performance was evaluated.

As apparent from Tables, the heat exchangers of Examples 1 to 40 manufactured by the manufacturing method of the present invention were excellent in corrosion resistance. Furthermore, in these heat exchangers, no fin detachment occurred after the SWAAT test for 960 hours, and brazed was good in condition.

To the contrary, in Comparative Example 1 which deviates from the stipulated range of the present invention, it was poor in corrosion resistance.

### INDUSTRIAL APPLICABILITY

The heat exchanger according to the present invention can be used as a condenser for a refrigerating cycle for use in, for example, automobile air-conditioning system.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” is meant as a non-specific, general reference and may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

1. A method for manufacturing a heat exchanger, the method comprising the steps of:
forming a thermally sprayed layer on a surface of an aluminum tube core by thermally spraying Al—Si series alloy brazing material onto the surface of the aluminum tube core to obtain a tube;
applying flux composite containing non-corrosive flux showing zinc substitution reaction onto a surface of the tube;
combining the tube with the fin; and
brazing the tube and the fin in an combined state.

2. A method for manufacturing a heat exchanger, the method comprising the steps of:
forming a thermally sprayed layer on a surface of an aluminum tube core by thermally spraying Al—Si series alloy brazing material onto the surface of the aluminum tube core to obtain a tube;
applying flux composite onto a surface of the tube, wherein the flux composite contains non-corrosive flux showing zinc substitution reaction and binder, the binder being resin having a property in which 90 mass % or more of the resin evaporates at a temperature of 350° C. when a differential thermal analysis is performed under a condition of a temperature rising rate of 20° C./minute;
combining the tube with the fin; and
brazing the tube and the fin in a combined state.

3. The method for manufacturing a heat exchanger as recited in claim 2, wherein butyl series resin is used as the resin.

4. A method for manufacturing a heat exchanger, the method comprising the steps of:
forming a thermally sprayed layer on a surface of an aluminum tube core by thermally spraying Al—Si series alloy brazing material onto the surface of the aluminum tube core to obtain a tube;
applying flux composite onto a surface of the tube, wherein the flux composite contains non-corrosive flux showing zinc substitution reaction and binder, the binder being polyethylene oxide having a property in which 90 mass % or more of the polyethylene oxide evaporates at a temperature of 350° C. when a differential thermal analysis is performed under a condition of a temperature rising rate of 20° C./minute;
combining the tube with the fin; and
brazing the tube and the fin in an combined state.

5. The method for manufacturing a heat exchanger as recited in claim 4, wherein a molecular weight of the polyethylene oxide is 10,000 to 1,500,000.

6. A method for manufacturing a heat exchanger, the method comprising the steps of:
forming a thermally sprayed layer on a surface of an aluminum tube core by thermally spraying Al—Si series alloy brazing material onto the surface of the aluminum tube core to obtain a tube;
applying flux composite onto a surface of the tube, wherein the flux composite contains non-corrosive flux showing zinc substitution reaction and binder, the binder being paraffin having a property in which 90 mass % or more of the paraffin evaporates at a temperature of 350° C. when a differential thermal analysis is performed under a condition of a temperature rising rate of 20° C./minute;
combining the tube with the fin; and
brazing the tube and the fin in an combined state.

7. The method for manufacturing a heat exchanger as recited in claim 6, wherein a molecular weight of the paraffin is 200 to 600.

8. The method for manufacturing a heat exchanger as recited in claim 6, wherein one of elements selected from the group consisting of paraffin wax, isoparaffin and cycloparaffin is used as the paraffin.

9. The method for manufacturing a heat exchanger as recited in any one of claims 2 to 8, wherein a mixed mass ratio in the flux composite is set so as to fall within the range of: the binder material/the flux component containing the non-corrosive flux showing zinc substitution reaction=20/80 to 80/20.

10. The method for manufacturing a heat exchanger as recited in any one of claims 1 to 9, wherein KZnF₃ is used as the flux component containing the non-corrosive flux showing zinc substitution reaction.

11. The method for manufacturing a heat exchanger as recited in any one of claims 1 to 10, wherein the flux component containing the non-corrosive flux showing zinc substitution reaction is applied by 5 to 20 g/m².

12. The method for manufacturing a heat exchanger as recited in any one of claims 1 to 11, wherein alloy brazing material containing Si: 6 to 15 mass % and the balance being Al and inevitable impurities is used as the Al—Si series alloy brazing material.

13. The method for manufacturing a heat exchanger as recited in any one of claims 1 to 11, wherein alloy brazing material containing Si: 6 to 15 mass %, at least either Cu: 0.3 to 0.6 mass % or Mn: 0.3 to 1.5 mass %, and the balance being Al and inevitable impurities is used as the Al—Si series alloy brazing material.

14. The method for manufacturing a heat exchanger as recited in any one of claims 1 to 11, wherein alloy brazing material containing Si: 6 to 15 mass %, at least either Cu: 0.35 to 0.55 mass % or Mn: 0.4 to 1.0 mass %, and the balance being Al and inevitable impurities is used as the Al—Si series alloy brazing material.

15. The method for manufacturing a heat exchanger as recited in any one of claims 1 to 14, wherein a fin with no brazing material clad is used as the fin.

16. The method for manufacturing a heat exchanger as recited in any one of claims 1 to 15, wherein a flat tube formed by an extrusion is used as the tube.

17. The method for manufacturing a heat exchanger as recited in any one of claims 1 to 16, wherein the brazing is performed at a heating temperature of 550 to 620° C.

18. A heat exchanger manufactured by the method as recited in any one of claims 1 to 17.
